(19) United States
(12) Patent Application Publication
(10) Pub. No.: US 2005/0125375 A1
(43) Pub. Date: Jun. 9, 2005

(54) System and method for customizing web-enabled data in ticker format

(76) Inventors: Patrick R. Lee, Bolingbrook, IL (US); Shyhshiun Chen, Naperville, IL (US); Ching-Yi Kung, Naperville, IL (US)

Correspondence Address: FISH & RICHARDSON P.C., 5000 BANK ONE CENTER, 1717 MAIN STREET, DALLAS, TX, 75201, US

(21) Appl. No.: 10/888,097

(22) Filed: Jul. 9, 2004

Related U.S. Application Data
(60) Provisional application No. 60/486,162, filed on Jul. 10, 2003.

(51) Int. Cl. G06F 7/00

(52) U.S. Cl. 707/1

(57) ABSTRACT

A method for customizing web-enabled data in ticker format comprises loading a ticker profile associated with a client. Web-enabled data is retrieved from a data provider in response to receiving a request from the client. The retrieved data is transformed into ticker format based on the loaded ticker profile and communicated to the client.

### RELATED APPLICATION

This application claims the priority under 35 U.S.C. §119 of provisional application Ser. No. 60/486,162 filed Jul. 10, 2003.

### TECHNICAL FIELD

This disclosure relates generally to the field of web-enabled data processing and, more particularly, to a system and method for customizing web-enabled data in ticker format.

### BACKGROUND

Current data providers typically provide display parameters with the requested data. These display parameters include title, icons, chart format, various links and other information used to present the data to a client in a more readable form. Typically, the client cannot customize this presentation. Further, conventional systems normally require that the data provider concurrently provides the data and the display parameters.

### SUMMARY

This disclosure provides a system and method for customizing web-enabled data in ticker format. In one embodiment, a method for customizing web-enabled data in ticker format comprises loading a ticker profile associated with a client. Web-enabled data is retrieved from a data provider in response to receiving a request from the client. The retrieved data is transformed into ticker format based on the loaded ticker profile and communicated to the client. The details of one or more embodiments of the disclosure are set forth in the accompanying drawings and the description below. Particular features, objects, and advantages of the disclosure will be apparent from the description and drawings and from the claims.

### DESCRIPTION OF DRAWINGS

FIG. 1 is a block diagram illustrating a system for customizing web-enabled data in a ticker format according to one embodiment of the present disclosure;

FIGS. 2A-B illustrate example web-enabled tickers in accordance with various embodiments of the system in FIG. 1; and

FIGS. 3A-B illustrate a flowchart of an example method for customizing web-enabled data in a ticker format according to one embodiment of the present disclosure.

### DETAILED DESCRIPTION

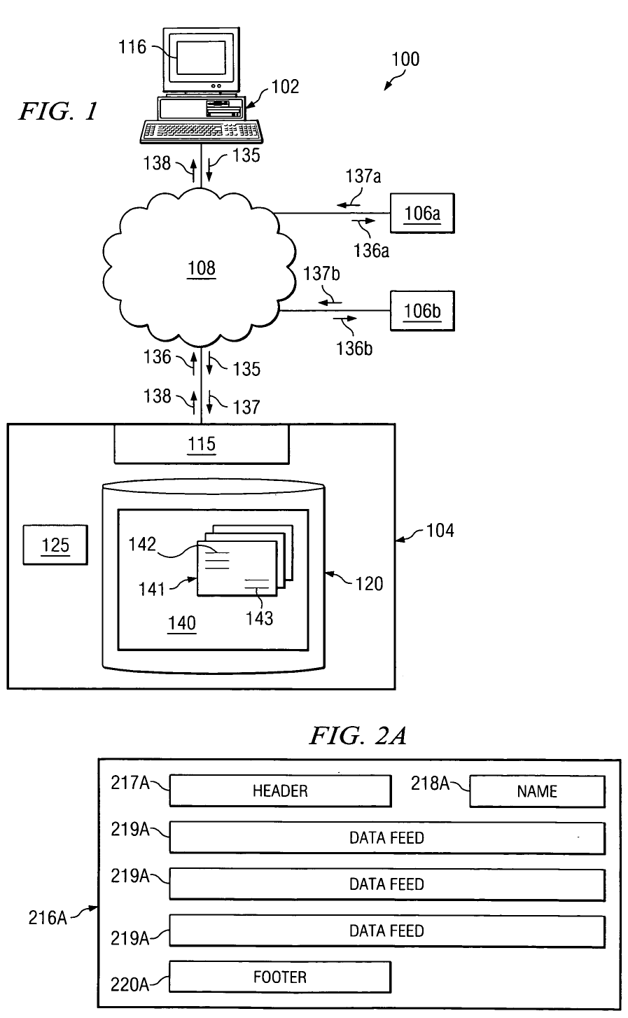

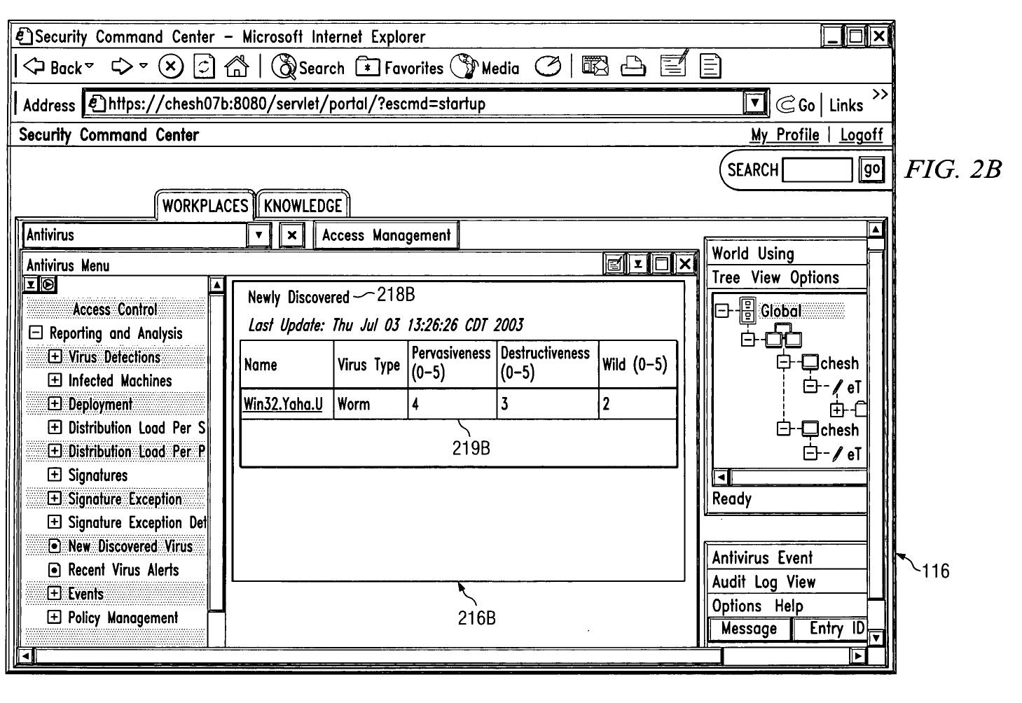

FIG. 1 illustrates a system 100 for customizing web-enabled data in a ticker format. At a high level, system 100 is a client/server environment comprising at least one client 102, a server 104, and one or more data providers 106, but may also be a standard computing environment or any other suitable environment. In general, system 100 comprises a system for providing client 102 with the ability to customize web-enabled data from one or more data providers 106 based on an associated ticker profile 141, normally stored on server 104. For example, system 100 may comprise an enterprise security management system that allows server 104 to retrieve multiple streams of web-enabled data from a plurality of security data providers 106 and customize the security data in a ticker format for presentation to client 102. System 100 retrieves the appropriate data from data provider 106 and automatically processes the retrieved data to generate HyperText Markup Language (HTML) pages for use by a ticker 216 (illustrated in FIG. 2). The term “automatically,” as used herein, generally means that the appropriate processing is substantially performed by system 100. It should be understood that automatically further contemplates any suitable user interaction with system 100. In one embodiment, system 100 allows clients 102 to view multiple data feeds in ticker 216, which in one embodiment is a scrolling, marquee display within a generic web browser.

Each client 102 may include input devices, output devices, mass storage media, processors, memory, interfaces, communication ports, or other appropriate components for communicating client requests 135 to server 104 and viewing the generated output. It will be understood that there may be any number of clients 102 coupled to server 104. As used in this document, client 102 is intended to encompass a personal computer, workstation, network computer, kiosk, wireless data port, personal data assistant (PDA), one or more processors within these or other devices, or any other suitable processing device. Moreover, “client 102” and “user of client 102” may be used interchangeably without departing from the scope of this disclosure. For example, client 102 may comprise a computer that includes an input device, such as a keypad, touch screen, mouse, or other device that can accept information, and an output device that conveys information associated with the operation of server 104 or clients 102, including digital data, visual information, or ticker profiles 141. Both the input device and output device may include fixed or removable storage media such as a magnetic computer disk, CD-ROM, or other suitable media to both receive input from and provide output to users of clients 102 through the ticker display, namely graphical user interface (GUI) 116.

GUI 116 comprises a graphical user interface operable to allow the user of client 102 to interface with system 100 to receive one or more data feed, each from one data provider 106, in ticker format. Generally, GUI 116 provides the user of client 102 with an efficient and user-friendly presentation of data provided by system 100, such as in a scrolling, marquee fashion. GUI 116 may comprise a plurality of displays having interactive fields, pull-down lists, and buttons operated by the user. In one example, GUI 116 presents the various web-enabled data feeds and receives commands from client 102. It should be understood that the term graphical user interface may be used in the singular or in the plural to describe one or more graphical user interfaces and each of the displays of a particular graphical user interface. Further, GUI 116 contemplates any graphical user interface, such as a generic web browser, that processes information in system 100 and efficiently presents the information to the user. Server 104 can accept data from client 102 via the web browser (e.g., Microsoft Internet Explorer or Netscape Navigator) and return the appropriate HTML or eXtensible Markup Language (XML) responses.

Server 104 includes memory 120 and processor 125 and comprises an electronic computing device operable to receive, transmit, process and store data associated with system 100. For example, server 104 may comprise a general-purpose personal computer (PC), a Macintosh, a workstation, a Unix-based computer, a server computer, or any other suitable device. According to one embodiment, server 104 may comprise a web server. In short, server 104 may comprise software and/or hardware in any combination suitable to present client 102 with ticker 216, which includes one or more web-enabled data feeds from one or more data providers 106. For example, if server 104 comprises a security server, then security server 104 may provide different security views, reporting of security infrastructure, visualization and reporting of security status, reporting of various security products, remote control of security, integration with internal or third party security, and any other suitable information in a ticker format.

FIG. 1 only provides one example of computers that may be used with the disclosure. For example, although FIG. 1 provides one example of server 104 that may be used with the disclosure, system 100 can be implemented using computers other than servers, as well as a server pool. The present disclosure contemplates computers other than general purpose computers as well as computers without conventional operating systems. As used in this document, the term “computer” is intended to encompass a personal computer, workstation, network computer, or any other suitable processing device. Computer server 104 may be adapted to execute any operating system including UNIX, Windows, or any other suitable operating system.

Server 104 includes interface 115 for communicating with other computer systems, such as client 102 and data provider 106, over network 108 in a client-server or other distributed environment. In certain embodiments, server 104 receives ticker profiles 141 from network 108 for storage in memory 120. Network 108 facilitates wireless or wireline communication between computer server 104 and any other computer. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations. Generally, interface 115 comprises logic encoded in software and/or hardware in a suitable combination and operable to communicate with network 108. More specifically, interface 115 may comprise software supporting one or more communications protocols associated with communications network 108 or hardware operable to communicate physical signals.

Memory 120 may include any memory or database module and may take the form of volatile or non-volatile memory including, without limitation, magnetic media, optical media, random access memory (RAM), read-only memory (ROM), removable media, or any other suitable local or remote memory component. In this embodiment, memory 120 includes or references at least ticker profile repository 140, but may also include any other appropriate data. Ticker profile repository 140 stores one or more customizable ticker profiles 141. Ticker profile repository 140 may receive ticker profiles 141 through interface 115 or from another process running on server 104. Repository 140 may be of any suitable format including XML documents, flat files, Btrieve files, comma-separated-value (CSV) files, SQL tables, relational database tables, and any other format operable to store at least one ticker profile 141.

Ticker profile 141 is associated with client 102 based on any appropriate characteristic. For example, server 104 may associate ticker profile 141 based on a selection by client 102 or a user group, client ID, IP address, logical location, a security level, or any other suitable characteristic of client 102. In general, ticker profile 141 provides client 102 with the ability to customize the presentation of data in the ticker. Ticker profile 141 comprises any file including at least one data feed element 142, which describes at least the appropriate data provider 106 from which the data is to be retrieved, and operable to be processed by server 104. Ticker profile 141 may be created by client 102, third party software vendor, or any other appropriate user of the respective product or loaded from a default profile. Ticker profile 141 may be in any electronic format such as, for example, an XML document, comma separated value (CSV) file, EFT record, or any other appropriate data format. In one embodiment, XML is used because it is easily portable, human-readable, and customizable. For example, ticker profile 141 may comprise the following high-level logical format:

```
<Ticker>
  <HeaderSection>
  . . .
  </HeaderSection>
  <FeedDataFormats>
  . . .
  </FeedDataFormats>
  <FooterSection>
  . . .
  </FooterSection>
</Ticker>
```

Generally, the above logical format provides an easily customizable, yet standard format operable to be used by ticker engine 130. For ease of understanding, this disclosure will illustrate client 102 customizing ticker profile 141; but it will be understood that the customization may be manual or automatic and may be performed by any appropriate user or computer including, but not limited to, software developers, managers, administrators, server 104, and data providers 106. According to one embodiment, client 102 may customize the presentation of the data using data feed elements 142 and attributes 143.

Data feed element 142 defines an interface to a particular data provider 106. For example, if system 100 is an enterprise security management system, then each data feed element 142 may retrieve security monitoring status reports or security-related product updates. According to one embodiment, data feed element 142 may include a specific URL to be used to locate the appropriate data provider 106 and retrieve the desired data. An example data feed element 142 is illustrated below:

```
<FeedDataFormat dataURL=“http://www.xyz.com” inputType=“http”>
<FeedTitle>
  . . .
<FeedTitle>
<Rolling/>
<ColumnHeaders>
  <ColumnHeader>
    . . .
  </ColumnHeader>
  <ColumnHeader>
    . . .
  </ColumnHeader>
  . . .
</ColumnHeaders>
<LinkRule>
  . . .
</LinkRule>
<LinkRule>
  . . .
</LinkRule>
</FeedDataFormat>
```

The above data feed element 142 is for illustration purposes only and any appropriate language, format, or logical design may be used such that ticker profile 141 is operable to be loaded by server 104 in order to customize the data feeds in ticker 216.

Customization of ticker profile 141 is, at least in part, further implemented through the use of attributes 143. Attribute 143 comprises any element included in ticker profile 141 that tailors the presentation of the data to client 102. Accordingly, attribute 143 may include, alternatively or in combination, a logical section of ticker profile 141 or display or report characteristics with the section. Attributes 143 may be stored in disparate places in ticker profile 141, such as tags within an XML file. For example, ticker profile 141 may include the following example tags and exemplary attributes 143:

<Ticker>

Attributes 143 ‘Name’ and ‘Description’ are typically used by GUI 116 to display the desired name and description of customized ticker 216.

<created><updated><accessed>

These attributes 143 may be used by GUI 116 to display various date/time stamps associated with the presentation of the data.

<HeaderSection>

One attribute 143 in this tag, called ‘frameRowHeight’, is used to control height of the header section frame. It can be specified in pixels, percentage, or ‘*’ (default value) which lets GUI 116 make adjustments based, at least in part, on the remaining space.

<HeaderText>The content of this tag is used to specify text string which will be displayed as title text in the top of HTML page. There are five additional attributes 143 which relate to font settings. The ‘font_face’ attribute 143 is the name of the font, which is default to ‘Arial’ font. The ‘font_size’ attribute 143 is ranged from 1 to 7, in which 7 is the largest size, and the default is 4. The ‘font_weight’ attribute 143 can be normal or bold and it's default to ‘normal’. The ‘font_style’ attribute 143 can be normal or italic and it's default to ‘normal’. The ‘font_color’ attribute 143 can be any valid HTML color representation and it's default to ‘004e4e’.

<Company Logo>

This element can specify an image file name which will be used as a company logo. There are two additional attributes 143, width and height, which may be used to specify the size of image to be displayed. If these attributes 143 are not specified, then the image may be shown using its default size.

<FeedName>

The content of this tag is typically used to specify a text string that will be displayed as feed name text in the HTML page. There are five additional example attributes 143 that relate to font settings. The ‘font_face’ attribute 143 is the name of the font, which is default to ‘Arial’ font. The ‘font_size’ attribute 143 is ranged from 1 to 7, in which 7 is the largest size and the default is 3. The ‘font_weight’ attribute 143 can be normal or bold and it's default to ‘normal’. The ‘font_style’ attribute 143 can be normal or italic and it's default to ‘normal’. The ‘font_color’ attribute 143 can be any valid HTML color representation and it's default to ‘004e4e’.

<Feed Logo>

This element can specify the image file name that is used as feed logo. There are two additional attributes 143, width and height, which may be used to specify the size of image to be displayed. If these attributes 143 are not specified, then the image will be shown with its original size.

<FeedDataFormat>

This tag is normally used to specify attributes 143 for a data feed element 142. There are often a number of attributes 143 within this tag, which are listed below:
dataURL: Specify an URL for input source, which will return the data in a particular web-enabled format, such as XML.
inputType: The value may be either “xml” or “http”. If it is “xml”, then the URL specified by dataURL points to a static XML file, otherwise, it might be “http”
update_interval: This is used to specify how often the ticker should query the URL to refresh its content. If the value is 0 (default) then there is no automatic refresh is done. According to one embodiment, the base unit is seconds, so “3” means 3 seconds.
inputTransXslt: If the web-enabled data returned by URL does not meet the syntax of data schema, then client 102 can set this attribute to use additional transformation process that translates incoming data into standard format as specified in data schema.
showDateTime: The value can be “y” or “n”. If “y” then date/time stamp will be shown. The default is “n”.
frameRowHeight: This is used to control height of the feed data frame. It can be specified in pixels, percentage, or ‘*’ (default value) which lets browser to make adjustment (based on the remaining space.)
frameBorder: The value can be “1” or “0”. If it's “1” then HTML frame border will be shown. The default is “0”.
frameBorderColor: The color of frame border. The value can be any valid HTML color.
tickerBorder: The value can be “y” or “n”. If “y” then a thick black border will be shown around the ticker box. The default is “n”.
width: This is used to specify the width of ticker to be displayed. The default value for this is 300 pixels.
height: This is used to specify the height of ticker to be displayed. The default value for this is 120 pixels.
bg_color: This is used to specify the background color of ticker. The default value is ‘light yellow’.
bg_image: This is used to specify the background image of ticker. The default value is empty string.
font_face: The name of the font, which may default to ‘Arial’ font.
font size: This is ranged from 1 to 7, in which 7 is the largest size and the default is set to 3.
font_weight: It can be normal or bold and is defaulted to ‘normal’.
font_style: It can be normal or italic and is defaulted to ‘normal’.
font_color: It can be any valid HTML color representation and is defaulted to ‘004e4e’.
   <FeedTitle>

The content of this tag is often used to specify a text string that will be displayed as feed title in the HTML page. There is one attribute 143 ‘type’ which is typically either a value of ‘text’ or ‘image’. There are five additional attributes 143 which are all related to font settings. The ‘font_face’ attribute 143 is the name of the font, which defaults to ‘Arial’ font. The ‘font_size’ attribute 143 is ranged from 1 to 7, in which 7 is the largest size and the default is set to 3. The ‘font_weight’ attribute 143 can be normal or bold and defaults to ‘normal’. The ‘font_style’ attribute 143 can be normal or italic and defaults to ‘normal’. The ‘font_color’ attribute 143 can be any valid HTML color representation and, when appropriate, defaults to ‘004e4e’.

<Rolling>

Ticker 216 may display the feed content(s) and roll it up in specified speed to make it appear like slow moving animation scroller. There are 3 additional attributes 143. Attribute ‘speed’ is used to specify how fast the rolling move should take. The default value for ‘speed’ is 100 milliseconds. Attribute ‘special_effect’ is often one of ‘none’, ‘pause’ or ‘translucent’ and the default is ‘none’. Attribute ‘pause interval’ is meaningful only when ‘special_effect’ is either ‘pause’ or ‘translucent’ and its default is set to 3000 milliseconds.

<Refresh>

When used, GUI 116 displays the feed content(s) continuously by using next content to replace the old content which makes it have a flash visual effect. This tag may include two attributes 143. Attribute ‘interval’ is used to specify how long the current content should stay before showing next content. The default value for ‘interval’ is 3000 milliseconds. Attribute ‘special_effect’ is normally one of ‘none’, ‘fading’ or ‘slide’ or ‘typing’ and the default is ‘none’.

<ColumnHeaders>

This element may be used to indicate that <ColumnHeader> tags may be used. There is one optional attribute 143, ‘visible’, which is used to specify whether the column headers should be shown. If it is ‘y’, the default, then every column header is shown, unless the individual column's <ColumnHeader> tag has an attribute ‘visible’ with value ‘n’ and, in that case, the specific individual column header won't appear. If the attribute is set to ‘n’, then no column header text will be visible.

<ColumnHeader>

May be used to identify string name for each column header of input data (if there is more than one column, i.e. there are more than one <VAL> tag in each <REC> tag of incoming data). The number of <ColumnHeader> tags are normally the same as the number of <VAL> tags within each incoming data's <REC> tags. Attribute 143 ‘visible’ may be used to identify whether this column (its header text and all its value in each row) should be visible or invisible.

<LinkRule>

This element may specify which column (or specific row data) to build a link for, and how it might be built. If the “Match” attribute 143 is “DataValue” then the attribute “Criteria” could be a valid regular expression. In the following example, the attribute of RULE tag is used to build a link for column 1 data, and the content of RULE tag is the format specifier used to create the link.

<LINK_RULE Match=“columnNumber”
Criteria=“1”>http:!!@node:@port/SMP/servlet/epPCMServlet?Auditname=@p1&am
p;Auditnode =@p2<!LINK_RULE>

where @p1 is for column 1 data and @p2 is for column 2 data. Moreover, there are two other variables @node and @port that are available, which respectively represent the data provider 106 node name and port number.
<FooterSection>This tag includes one attribute 143 called ‘frameRowHeight’, which is used to control height of the header section frame. It can be specified in pixels, percentage, or ‘*’ which lets browser to make adjustment (based on the remaining space.). The default value is ‘8%’ if not specified.
<InfoLink>

The content of this tag is used to specify a text string that is displayed as a hyperlink in the HTML page after “More Info:” string in footer section. There are optional five attributes 143 which are all related to font settings.

It will be understood that the preceding example elements, tags, and attributes 143 are for illustration purposes only. Ticker profile 141 may be in any logical or physical format operable to be processed by server 104 and include none, some, or all of the illustrated tags and attributes 143, as well as additional attributes 143 or tags not illustrated.

Returning to server 104, illustrated server 104 also includes processor 125. Processor 125 executes instructions and manipulates data to perform the operations of server 104 such as, for example, a central processing unit (CPU), an application specific integrated circuit (ASIC) or a field-programmable gate array (FPGA). Although FIG. 1 illustrates a single processor 125 in server 104, multiple processors 125 may be used according to particular needs and reference to processor 125 is meant to include multiple processors 125 where applicable. In the embodiment illustrated, server 104 includes ticker engine 130 that processes external data based on ticker profiles 141. Ticker engine 130 could include any hardware, software, firmware, or combination thereof operable to receive a client request 135 from client 102, retrieve data from data provider 106 on a target machine in a suitable format, and automatically transform the data into ticker format displayed by any generic web browser, such as GUI 116. Further, ticker engine 130 may allow client 102 or the software product vendor to submit or customize ticker profiles 141. For example, ticker engine 130 may be written in any appropriate computer language including C, C++, Java, Visual Basic, Perl, and others. It will be understood that while ticker engine 130 is illustrated as a single multi-tasked module, the features and functionality performed by these engine may be performed by multiple modules such as, for example, a data retrieval module, a transformation module, and a presentation engine. Moreover, while not illustrated, ticker engine 130 may comprise a child module of another local or remote software application. In one embodiment, ticker engine 130 loads ticker profile 141 and automatically formats data into the desired ticker format based on the loaded ticker profile 141 and presents the resulting ticker 216 to client 102.

Data provider 106 typically comprises a third party web server or an enterprise agent residing on a target machine. It will be understood that the target machine may be remote or on-site; further, the target machine may represent a separate process running on server 104 or client 102 without departing from the scope of this disclosure. Generally, data provider 106 receives requests from server 104 and retrieves data from the software product residing on target machine. Once the data has been gathered, data provider 106 may communicate the data to server 104 or server 104 may retrieve the data from data provider 106, as appropriate. Server 104 compiles web-enabled data from the appropriate data providers 106 and transforms it into ticker 216.

In one aspect of operation, client 102 communicates a client request 135 to server 104. Before client request 135 is received by server 104, system 100 may require that client 102 log on to server 104 as appropriate. For example, if system 100 comprises an enterprise security management system, then server 104 may first verify client 102 accepting before client request 135. Once server 104 receives client request 135, server 104 loads ticker profile 141 associated with requesting client 102. According to one embodiment, if there is no ticker profile 141 associated with requesting client 102, then server 104 may load a default ticker profile. Server 104 then processes client request 135 to produce ticker 216 with the appropriate data feeds. For example, if server 104 comprises webserver components, then server 104 may use the Apache Jakarta Tomcat servlet engine or other similar component to process client request 135. Based upon client request 135, ticker engine 130 communicates server request 136 to data provider 106 in order to retrieve the desired web-enabled data. According to one embodiment, there may be more than one data provider 106 necessary to fulfill client request 135. Accordingly, as illustrated in FIG. 1, a first data provider 106a may receive a first server request 136a and a second data provider 106b may receive a second, and at least partially different, server request 136b. After suitable processing, the requisite data provider 106 communicates output 137, which comprises web-enabled data. For example, first data provider 106a may communicate output 137 a in XML format. Once output 137 is received by server 104, ticker engine 130 formats the data into ticker 216 based on the loaded ticker profile 141. For each data feed 142 specified in ticker profile 141, ticker engine 130 often generates an HTMLet, each of which is included in a master HTML page 138 that is communicated to requesting client 102.

FIGS. 2A-B illustrate examples ticker 216 in accordance with various embodiments of system 100. Generally, ticker 216 allows server 104 to provide data from one or more data providers 106 to client 102 in a customized ticker format. This customized format includes scrolling, background, images, fonts, rolling, refreshing, and any other suitable data presentation characteristic. According to one embodiment, illustrated in FIG. 2A, ticker 216 a is created with one master HTML page 138 and one or more HTMLets. Illustrated example ticker 216 a includes a ticker format of header 217a, ticker name 218a, three data feeds 219a, and footer 220a. Header 217a normally displays a text string at the top of ticker 216a. Ticker name 218 generally displays the name given to this particular ticker format. Graphical data feed 219a corresponds to a data feed element 142 in ticker profile 141. Data feeds 219a may each display data retrieved from the same data provider 106 or different data providers 106 without departing from the scope of this disclosure. Footer 220a displays a text string at the bottom of ticker 216a. In short, this ticker format is defined by ticker profile 141, such as the following XML example:

```
<HeaderSection>
  <HeaderText>
    . . .
  </HeaderText>
  <FeedLogo> or <FeedName>
    . . .
  </FeedLogo> or </FeedName>
</HeaderSection>
<FeedDataFormats>
  <FeedDataFormat>
    . . .
  </FeedDataFormat>
  <FeedDataFormat>
    . . .
  </FeedDataFormat>
  <FeedDataFormat>
    . . .
  </FeedDataFormat>
    . . .
</FeedDataFormats>
<FooterSection>
  <InfoLink>
    . . .
  </InfoLink>
</FooterSection>
```

FIG. 2B illustrates another embodiment of ticker 216 in accordance with system 100. The illustrated example ticker 216b comprises a ticket name 218b and a single data feed 219b. In this embodiment, ticker 216b is embedded in a generic webpage displayed using GUI 116. For example, the webpage may present data from a central security server, while data feed 219b illustrates data from a third party in ticker format such as scrolling, automatically refreshing, and other suitable ticker characteristics. As with FIG. 2A, this ticker format is defined by ticker profile 141, such as the following XML example:

```
<HeaderSection>
  <HeaderText>
    . . .
  </HeaderText>
</HeaderSection>
<FeedDataFormats>
  <FeedDataFormat>
    . . .
  </FeedDataFormat>
</FeedDataFormats>
```

It will be understood that ticker 216, illustrated by example tickers 216a and 216b, is for illustration purposes only and may include any number of HTMLets or data feeds 219 and may be defined using any appropriate ticker profile 141.

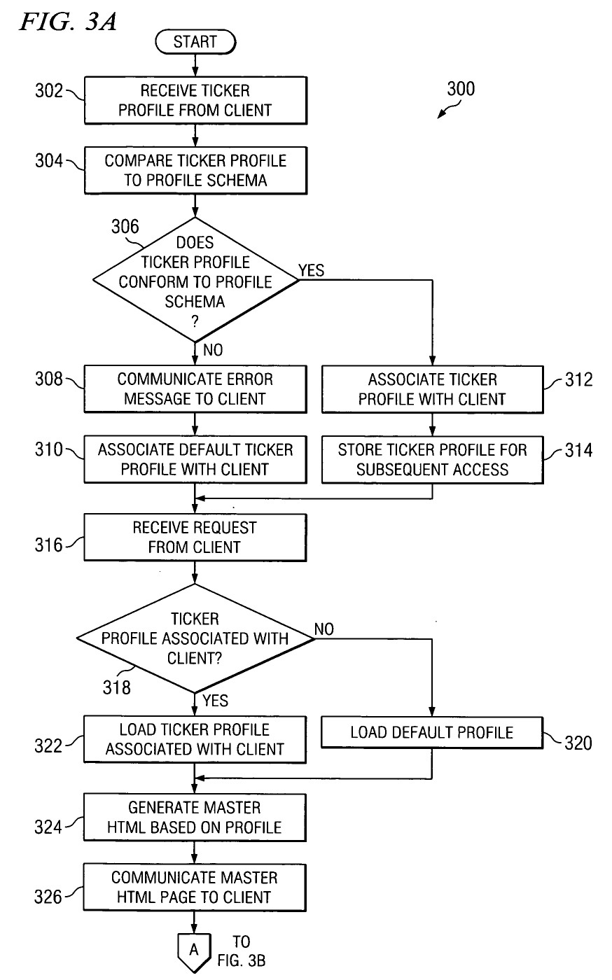

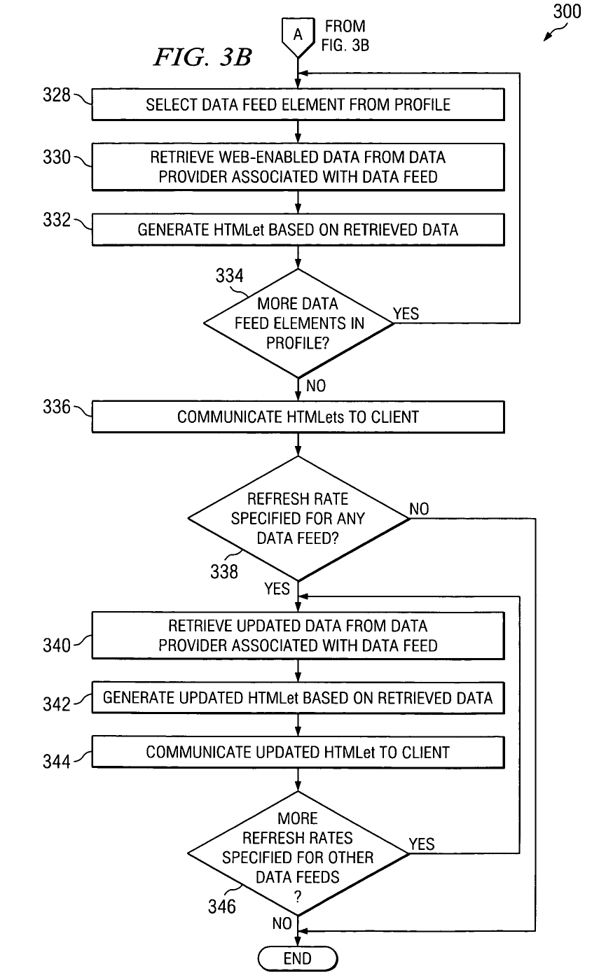

FIGS. 3A-B illustrate a flow chart of an exemplary method 300 for presenting a customized ticker 216, including one or more data feeds, to client 102. Method 300 is described in respect to system 100. However, any other suitable system may use method 300 to customize tickers 216 based on ticker profiles 141 without departing from the scope of this disclosure. Generally, method 300 describes server 104 retrieving multiple data feeds from data providers 106 and presenting ticker 216 to client 102 based on customizable ticker profile 141. More specifically, server 104 uses attributes 143 to tailor the presentation of the data retrieved from data providers 106 during any step in method 300, as appropriate.

Server 104 receives ticker profile 141 from client 102 via network 108 at step 302. At step 304, ticker engine 130 compares the received ticker profile 141 to a profile schema, normally stored in memory 120. At decisional step 306, ticker engine 130 determines if ticker profile 141 conforms to the profile schema. If ticker profile 141 does not conform to the profile schema, then server 104 communicates an error message to client 102 at step 308. Then, ticker engine 130 associates a default ticker profile with client 102 at step 310. In an alternative embodiment, ticker engine 130 may process the non-conforming ticker profile 141 such that it can conform to the profile schema without departing from the scope of this disclosure. Returning to decisional step 306, if the ticker profile conforms to the profile schema, then ticker engine 130 associates ticker profile 141 with client 102 at step 312. Once ticker profile 141 has been associated with client 102, then ticker engine 130 stores ticker profile 141 in ticker profile table 140 for subsequent access by server 104 at step 314. Once ticker profile 141 has been associated with client 102, then processing proceeds to steps 316 through 346 where a client request 135 from client 102 is processed.

Server 104 receives client request 135 from client 102 at step 316. It will be understood that client 102 communicating client request 135 and client 102 that communicates ticker profile 141 may be the same or different clients 102 without departing from the scope of this disclosure. At decisional step 318, ticker engine 130 determines if there is a ticker profile 141 associated with requesting client 102. Ticker engine 130 may determine whether there is a ticker profile 141 associated with client 102 using any appropriate technique or any characteristic of client 102 or client request 135. If there is not a ticker profile 141 associated with client 102, then the default ticker profile 141 is loaded at step 320. Otherwise, ticker profile 141 associated with client 102 is loaded by ticker engine 130 at step 322. Once a suitable ticker profile 141 has been loaded, ticker engine 130 generates a master HTML page 138 based on ticker profile 141 at step 324. Next, at step 326, server 104 communicates the generated master HTML page 138 to client 102 via network 108. After master HTML page 138 has been generated and communicated to client 102, processing proceeds to step 328 to 346 where individual data feeds 142 are processed and communicated to client 102 in a ticker format.

According to one embodiment, master HTML page 138 does not yet include individual data feeds from data providers 106. Accordingly, at step 328, ticker engine 130 selects a first data feed element 142 from ticker profile 141. Once data feed element 142 has been selected, ticker engine 130 retrieves web-enabled data from the appropriate data provider 106 at step 330. It will be understood that data provider 106 may be internal or external to system 100 and may comprise a third party data provider without departing from the scope of this disclosure. Next, at step 332, ticker engine 130 generates an HTMLet, which may be a small piece of HTML code, based on the retrieved web-enabled data. Once the HTMLet has been generated by ticker engine 130, ticker engine 130 determines if there are more data feed elements 142 in ticker profile 141 at decisional step 334. If there are more data feed elements 142 to be processed, then execution returns to step 328 where the next data feed element 142 is selected from ticker profile 141. Otherwise, substantially all of the generated HTMLets are inserted into master HTML page 138 to create ticker 216 and communicated to client 102 at step 336.

After the first set of HTMLets have been generated and communicated to client 102, ticker engine 130 determines if there is a refresh rate attribute 143 specified for any particular data feed 142 at decisional step 338. If there is no refresh rate attribute 143 specified for any data feed 142, then processing ends for this particular request by client 102. Otherwise processing proceeds to step 340, where ticker engine 130 retrieves updated web-enabled data from the data provider for the specified data feed 142. Next, ticker engine 130 generates an updated HTMLet based on the updated retrieve data at step 342. Once the updated HTMLet has been generated, server 104 communicates the updated HTMLet to client 102 at step 344. Processing then proceeds to decisional step 346, where ticker engine 130 determines if additional data feeds 142 include refresh rate attributes 143 as defined in ticker profile 141. If there are additional data feeds elements 142 with refresh rate attributes 143, then execution returns to step 340. Otherwise processing ends for this particular client request 135 by client 102.

The preceding flowchart and accompanying description illustrate only an exemplary method 300 for server 104 to provide customized tickers 216 to client 102 using associated ticker profile 141. However, system 100 contemplates server 104 using any suitable technique for performing these tasks. Thus, many of the steps in this flowchart may take place simultaneously and/or in different orders than as shown. Moreover, server 104 may use methods with additional steps, fewer steps, and/or different steps, so long as the methods remain appropriate.

Although the present disclosure has been described in detail, it should be understood that various changes, substitutions and alterations can be made hereto without departing from the sphere and scope of the disclosure as defined by the appended claims.

1. A method for customizing web-enabled data in ticker format, comprising:
loading a ticker profile associated with a client, the ticker profile comprising at least one data feed element;
retrieving web-enabled data from at least one data provider in response to receiving a request from the client;
transforming the retrieved data into ticker format based on the loaded ticker profile; and
communicating the transformed data to the client.

2. The method of claim 1, the ticker profile further comprising display attributes and report attributes.

3. The method of claim 1, the data provider comprising a first data provider and the retrieved data comprises a first set of data, the method further comprising:
retrieving second set of data from second data provider, the second set of data in a format different from the first of data;
transforming the second set of data based on the loaded ticker profile; and
communicating the transformed second set of data to the clients at substantially the same time as the first set of data.

4. The method of claim 1, the ticker profile comprising a logical location of the data provider.

5. The method of claim 1, the retrieved data in XML format and the method further comprising transforming the XML data into one or more Hyper Text Markup Language (HTML) pages or more using eXtensible Stylesheet Language: Transformation (XSLT).

6. The method of claim 2, the profile further comprising a refresh rate and the method further comprising:
retrieving updated data from the data provider based on the refresh rate transforming the updated data based on the loaded profile; and
communicated the transformed update data to the client.

7. The method of claim 1, further comprising:
locating a profile associated with the client; and
in response to not locating the associated profile, loading a default profile.

8. The method of claim 1, further comprising localizing data for the client.

9. The method of claim 8, wherein localizing data for the client comprises translating data into a language different from language of data provider.

10. The method of claim 1, further comprising receiving a profile from the client;
comparing the received profile to a profile schema;
in response to the received profile conforming to the profile schema, storing it for subsequent access; and
in response to the received profile not conforming to the profile schema:
communicating a deny profile message to the client; and
automatically associating a default profile with the client.

11. Software for customizing web-enabled data in ticker format, the software operable to:
load a ticker profile associated with a client, the ticker profile comprising at least one data feed element;
retrieve web-enabled data from data provider in response to receiving a request from the client;
transform the retrieved data into ticker format based on the loaded ticker profile; and
communicate the transformed data to the client.

12. The software of claim 11, the ticker profile further comprising display attributes and report attributes.

13. The software of claim 11, the data provider comprising a first data provider and the retrieved data comprising a first set of data, the software further operable to:
retrieve second set of data from second data provider, the second set of data in a format different from the first of data;
transform the second set of data based on the loaded profile; and
communicate the transformed second set of data to the clients at substantially the same time as the first set of data.

14. The software of claim 11, the ticker profile comprising a logical location of the data provider.

15. The software of claim 11, wherein the retrieved data is in XML format and the software further operable to transform the XML data into one or more Hyper Text Markup Language (HTML) pages using eXtensible Stylesheet Language: Transformation (XSLT).

16. The software of claim 12, the profile further comprising a refresh rate and the software further operable to:
retrieve updated data from the data provider based on the refresh rate;
transforming the updated data based on the loaded profile; and
communicate the transformed update data to the client.

17. The software of claim 11, further operable to:
locate a profile associated with the client; and
in response to not locating the associated profile, load a default profile.

18. The software of claim 11, further operable to localize data for the client.

19. The software of claim 18, wherein localizing data for the client comprises the software operable to translate data into a language different from the language of the data provider.

20. The software of claim 11, further operable to:
receive a profile from the client;
compare the received profile to a profile schema;
in response to the received profile conforming to the profile schema, store it for subsequent access; and
in response to the received profile not conforming to the profile schema:
communicate a deny profile message to the client; and
automatically associate a default profile with the client.

21. A system for customizing web-enabled data in ticker format, comprises:
memory operable to store a plurality of ticker profiles, each ticker profile comprising at least one data feed element; and
one or more processors collectively operable to:
load one of the ticker profiles, the loaded ticker profile associated with a client;
retrieve web-enabled data from a data provider in response to receiving a request from the client;
transform the retrieved data into ticker format based on the loaded ticker profile; and
communicate the transformed data to the client.

22. The system of claim 21, the ticker profile further comprising display attributes and report attributes.

23. The system of claim 21, the data provider comprising a first data provider and the retrieved data comprising a first set of data, the one or more processors further operable to:
retrieve second set of data from a second data provider, the second set of data in a format different from the first of data;
transform the second set of data based on the loaded profile; and
communicate the transformed second set of data to the clients at substantially the same time as the first set of data.

24. The system of claim 21, the ticker profile comprising a logical location of the data provider.

25. The system of claim 21, the retrieved data in XML format and the processors further operable to transform the XML data into one or more Hyper Text Markup Language (HTML) using eXtensible Stylesheet Language: Transformation (XSLT).

26. The system of claim 22, the profile further comprising a refresh rate and the one or more processors further operable to:
retrieve updated data from data provided based on the refresh rate;
transform the updated data based on the loaded ticker profile; and
communicate the transformed update data to the client.

27. The system of claim 21, the one or more processors further operable to:
locate the ticker profile associated with the client; and
in response to not locating the associated ticker profile, load a default profile.

28. The system of claim 21, the one or more processors further operable to localize data for the client.

29. The system of claim 28, wherein the one or more processors operable to localize data for the client comprises the one or more processors operable to translate data into a language different from a language of the data provider.

30. The system of claim 21, the one or more processors further operable to:
receive a profile from the client;
compare the received profile to a profile schema;
in response to the received profile conforming to the profile schema, store it in memory for subsequent access; and
in response to the received profile not conforming to the profile schema:
communicate a deny profile message to the client; and
automatically associate a default profile with the client.

31. A system for customizing web-enabled data in ticker format, comprising:
means for loading a ticker profile associated with a client, the ticker profile comprising at least one data feed element;
means for retrieving web-enabled data from a data provider in response to a received request from the client;
means for transforming the retrieved data into ticker format based on the loaded ticker profile; and
means for communicating the transformed data to the client.
